(19) United States
(12) Patent Application Publication
(10) Pub. No.: US 2010/0269590 A1
(43) Pub. Date: Oct. 28, 2010

(54) SENSOR SYSTEM

(76) Inventors: Sebastian GUENTHER, Tuebingen (DE); Nicolaus Ulbrich, Gomaringen (DE); Volker Materna, Eisenach (DE)

Correspondence Address: KENYON & KENYON LLP, ONE BROADWAY, NEW YORK, NY, 10004, US

(21) Appl. No.: 12/729,992

(22) Filed: Mar. 23, 2010

(30) Foreign Application Priority Data
Apr. 22, 2009 (DE) 102009002559.6

(51) Int. Cl. G01P 15/02; G01P 1/02

(52) U.S. Cl. 73/514.15; 73/431

(57) ABSTRACT

A sensor system, in particular an acceleration sensor system, includes a sensor element and a cover element, at least one side of the sensor element having a covering provided by the cover element, and the cover element being at least partially designed as an infrared-protection element.

### BACKGROUND INFORMATION

Sensor systems are generally known. For example, a micromechanical acceleration sensor having a flywheel mass in the form of a rocker that is deflectable in the z-direction relative to a substrate, is known from German Patent Application No. DE 10 2006 026 880. The flywheel mass is suspended by an anchoring device on the substrate in such a way that the geometry of the rocker is asymmetrical relative to a torsional axis formed by the anchoring device. In addition, this asymmetrical geometry results in a mass distribution that is asymmetrical relative to the torsional axis, so that an acceleration of the micromechanical acceleration sensor in the z-direction induces a deflection of the flywheel mass relative to the substrate due to inertial forces. This deflection can be capacitively measured by electrodes on one or both sides of the torsional axis and by corresponding counter-electrodes on the substrate.

### SUMMARY OF THE INVENTION

The sensor system according to the present invention has the advantage over the related art that undesirable offset variations of the sensor element caused by infrared irradiation are eliminated or are substantially reduced, thereby significantly enhancing the measuring accuracy of the sensor system. This is accomplished in that the sensor system has a cover element which functions at least partially as an infrared-protection element. An infrared-protection element along the lines of the present invention encompasses protection elements which prevent the transmission of infrared radiation and/or substantially reduce the intensity of the infrared radiation during transmission thereof and/or exhibit a comparatively poor thermal conductivity, so that incident infrared radiation merely results in a relatively insignificant warming of the infrared-protection element. This has the particular consequence that the infrared-protection element likewise has only a comparatively small fraction of infrared radiation in the emission spectrum. Infrared radiation preferably encompasses electromagnetic thermal radiation in the region greater than 750 nm. It is particularly important for the sensor element to be shielded from infrared radiation because the sensor structures typically have seismic masses which, on the one hand, due to their small mass in comparison to the substrate of the sensor element, only have a very low thermal capacity, and, on the other hand, due to the suspension thereof merely by thin spring elements, exhibit a relatively good thermal insulation from the substrate. Therefore, when subjected to infrared irradiation, the seismic mass heats up much more intensely than does the substrate, resulting in a relatively substantial offset variation due to temperature deformation of the seismic mass and/or due to the Seebeck effect. This is also due to the fact that the sensor system offset is typically compensated by a temperature compensation that is performed in the thermal equilibrium of the sensor system. In the case of the sensor system according to the present invention, an offset variation due to incident infrared radiation is advantageously suppressed.

One preferred further embodiment provides that the cover element include a capping wafer, a doped region of the capping wafer being provided, in particular, as an infrared-protection element. It is particularly advantageous that the infrared-protection element may be manufactured relatively simply and cost-effectively. The doping is producible in standard semiconductor processes, in particular, and preferably serves as an absorption element, so that incident infrared radiation is absorbed by the doped region, i.e., by the material of the capping wafer, in particular, silicon. In one especially preferred specific embodiment, the sensor system additionally features a housing, the capping wafer designed as an infrared-protection element shielding the sensor system from infrared radiation of the housing. This is particularly advantageous for housings made of metal, since these types of housings heat up relatively quickly and transfer the heat by infrared radiation to the sensor system.

Another preferred embodiment provides that the cover element encompass a sensor housing and/or a sensor housing cover, the sensor element being configured at least partially within the sensor housing. Thus, the sensor system is already advantageously shielded by the shielding sensor housing from external infrared radiation, so that a heating of the sensor housing is also preferably prevented. It is particularly preferred that the sensor system encompass both a capping wafer designed as an infrared-protection element, as well as a sensor housing designed as an infrared-protection element, so that the sensor element is doubly protected from infrared radiation.

Another preferred embodiment provides that a sensor housing cover be provided as an infrared-protection element that is thermally insulated by the sensor housing and/or by the sensor element. Thus, it is particularly advantageous for the sensor system to be shielded by an existing or known sensor housing, it merely being necessary that the sensor housing cover be designed as an infrared-protection element. It is particularly advantageous that the sensor housing cover include plastic that is virtually impervious to infrared radiation.

Another preferred embodiment provides that the cover element include a potting compound, which is located, in particular, between the sensor housing and the sensor element and/or between the sensor housing cover and the sensor element. A comparatively simple and cost-effective shielding of the sensor element is to be achieved very advantageously by simply “filling” the interior space of the sensor housing with the infrared-opaque potting compound. It is especially preferred that the potting compound be used at the same time to provide shielding from infrared radiation and to protect the sensor system from mechanical influences. It is especially preferred that the potting compound contain ruthenium oxide.

Another preferred embodiment provides that the infrared-protection element encompass a reflection and/or absorption element, so that incident infrared radiation is absorbed and/or reflected back by the infrared-protection element, thereby reducing or preventing the transmission of the infrared radiation in the direction of the sensor element.

Another preferred embodiment provides that the infrared protection element include a doped region, a metal layer, a dielectric layer, a dielectric layer stack and/or a plastic element, so that, on the one hand, the incident infrared radiation is advantageously absorbed and/or reflected and, on the other hand, the infrared-protection element is relatively simple to implement and is cost-effective, in particular, in standard manufacturing processes. It is also preferable that the infrared-protection element not require any additional space.

Another preferred embodiment provides that the infrared-protection element be located on a side of the cover element facing the sensor element and/or on a side of the cover element facing away from the sensor element, so that, depending on the sensor design and manufacturing method, an infrared-protection element may be advantageously realized that is comparatively simple to implement.

Another preferred embodiment provides that the cover element include a doped region and/or a coating of the sensor element and, in particular, of a seismic mass of the sensor element. Thus, the infrared-protection element is implemented very advantageously directly on the sensor element, so that, on the one hand, there is no need for any design modifications on the sensor housing, respectively on the capping wafer for infrared shielding and, on the other hand, the infrared-protection element is to be integrated in the sensor structure directly and relatively compactly in terms of spatial requirements. It is also possible to incorporate the manufacturing of the infrared-protection element directly in the manufacturing of the sensor element.

Another preferred embodiment provides for the sensor element to include an acceleration sensor that is sensitive, in particular, perpendicularly and/or in parallel to a main extension plane of a substrate of the sensor element, so that an offset variation is possible, in particular, for sensors that are supposed to ensure a comparatively high measuring resolution. In addition, a high measuring resolution is ensured over a broader temperature range.

Another preferred embodiment provides for the seismic mass to be designed as a rocker structure having an asymmetrical mass distribution. It is particularly advantageous that sensors having a rocker structure be shielded from infrared radiation, since, otherwise, there is the danger of a relatively too intense heating of the seismic mass due to the good thermal insulation and the low thermal capacity of the seismic mass when subjected to infrared irradiation, which would result in an offset variation that seriously degrades the measuring accuracy of the sensor.

### BRIEF DESCRIPTION OF THE DRAWINGS

FIG. 1 shows a schematic sectional view of a sensor system in accordance with a first specific embodiment of the present invention.

FIG. 2 shows a schematic sectional view of a sensor system in accordance with a second specific embodiment of the present invention.

FIG. 3 shows a schematic sectional view of a sensor system in accordance with a third specific embodiment of the present invention.

FIG. 4 shows a schematic sectional view of a sensor system in accordance with a fourth specific embodiment of the present invention.

FIG. 5 shows a schematic sectional view of a sensor system in accordance with a fifth specific embodiment of the present invention.

FIG. 6 shows a schematic sectional view of a sensor system in accordance with a sixth specific embodiment of the present invention.

### DETAILED DESCRIPTION

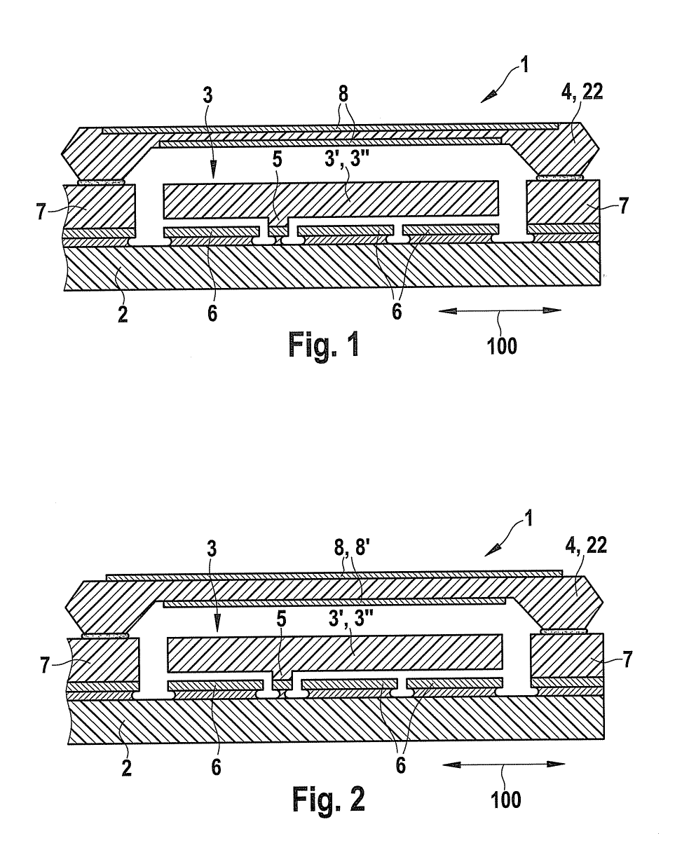

FIG. 1 shows a schematic sectional view of a sensor system 1 in accordance with a first specific embodiment of the present invention, sensor system 1 having a substrate 2, a sensor element 3, and a cover element 22 designed as a capping wafer 4. Sensor element 3 is designed as a seismic mass in the form of a rocker structure 3′, seismic mass 3″ being secured by a spring element 5 to substrate 2 in such a way that a swinging of seismic mass 3″ relative to the substrate is possible in one direction in parallel to a main extension plane 100 of substrate 2. Thus, it is possible to detect acceleration forces acting perpendicularly to main extension plane 100 since, relative to spring element 5, seismic mass 3″ has an asymmetrical mass distribution, so that the acceleration forces effect a swinging of seismic mass 3″ out of the neutral position. The deflection of seismic mass 3″ is capacitively measured by fixed electrodes 6, fixed electrodes 6 being anchored to substrate 2, and seismic mass 3″ acting as a counter-electrode to fixed electrodes 6, and thus a deflection of seismic mass 3″ leading to a measurable change in the electrical capacitance between fixed electrodes 6 and the counter-electrode. Fixed electrodes 6, as well as the connection of seismic mass 3″ are preferably designed as polysilicon tracks, which are preferably connected by a patterned silicon dioxide layer to substrate 2. The partially self-supporting seismic mass 3″ and further structures 7 are formed from epitaxial silicon on the polysilicon tracks. Fixed electrodes 6 are configured perpendicularly to main extension plane 100 between self-supporting regions of the seismic mass and substrate 2. Seismic mass 3″ is covered by cover element 22 in the form of capping wafer 4, so that seismic mass 3″ is configured perpendicularly to main extension plane 100 between capping wafer 4 and substrate 2. In this context, the capping wafer is joined by an adhesive layer or a seal glass to further structures 7. At least in one region overlapping seismic mass 3″ perpendicularly to main extension plane 100, the capping wafer is designed as infrared-protection element 8, capping wafer 4, in particular, including a silicon, and infrared-protection element 8 being formed, in particular, as a doping of capping wafer 4 on a side facing seismic mass 3″ and on a side of capping wafer 4 facing away from seismic mass 3″. The doping is formed in such a way that infrared radiation is absorbed by the silicon in the region of the doping.

FIG. 2 shows a schematic sectional view of a sensor system 1 in accordance with a second specific embodiment of the present invention, the second specific embodiment being substantially identical to first specific embodiment illustrated in FIG. 1, infrared-protection element 8 being formed as absorption and/or reflection layer 8′ on a side facing seismic mass 3″ and on a side of capping wafer 4 facing away from seismic mass 3″. In this context, absorption and/or reflection layer 8′ encompasses a metallic coating, a dielectric layer and/or a layer stack.

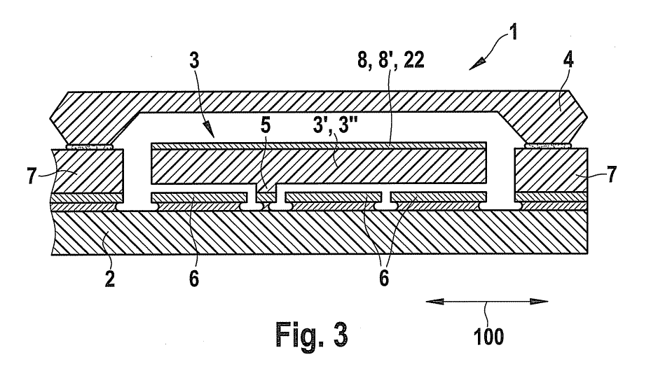

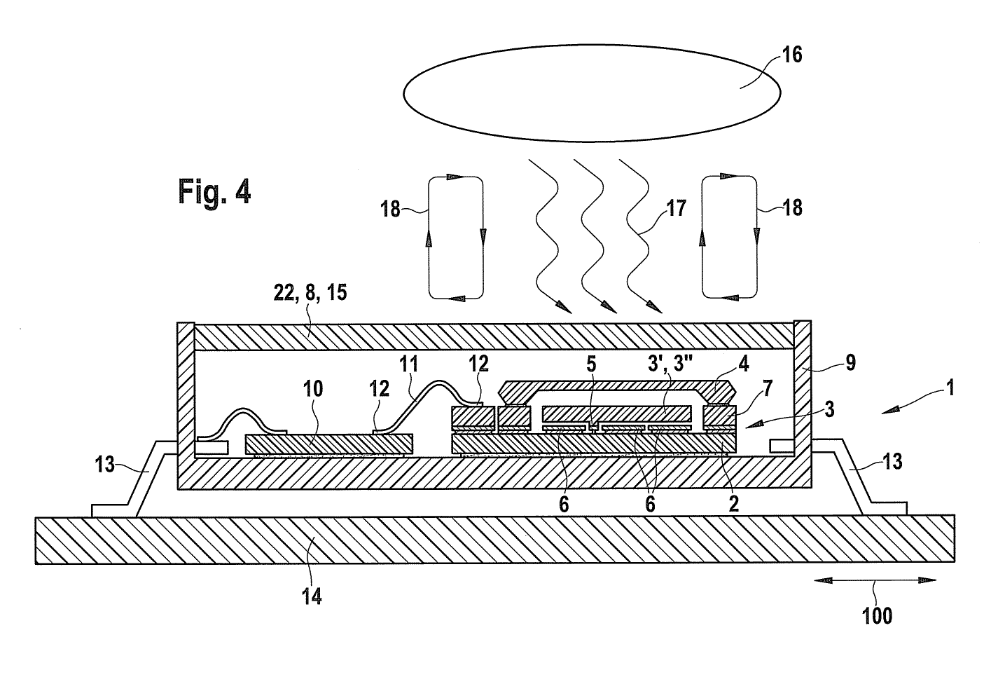

FIG. 3 shows a schematic sectional view of a sensor system 1 in accordance with a third specific embodiment of the present invention, the third specific embodiment being substantially identical to the second specific embodiment illustrated in FIG. 2, capping wafer 4 having no infrared-protection element 8; rather sensor element 3 including an infrared-protection element 8 in the form of an absorption and/or reflection layer 8′, which, in particular, includes a metallic coating, a dielectric layer and/or a layer stack on a side of seismic mass 3″ facing capping wafer 4.

FIG. 4 shows a schematic sectional view of a sensor system 1 in accordance with a fourth specific embodiment of the present invention, the fourth specific embodiment being substantially identical to the first specific embodiment illustrated in FIG. 1, capping wafer 4 not having any infrared-protection element 8; rather, sensor system 1 having a cover element 22 in the form of a sensor housing 9 which completely surrounds sensor element 3 and is at least partially designed as infrared-protection element 8. Configured exemplarily in sensor housing 9 is another chip 10 which is connected electroconductively via a bonding wire 11 and corresponding bonding pads 12 to sensor element 3, sensor housing 9 having housing pins 13 which are contacted exemplarily by a circuit board 14 to contact further chip 10 and/or sensor element 3. Sensor housing 9 has a sensor housing cover 15, which is made of plastic that is opaque to infrared radiation and is thermally insulated from remaining sensor housing 9. To illustrate the shielding, FIG. 4 schematically shows an external heat source 16 that radiates infrared radiation 17 in the direction of sensor element 3. In addition, heat is transferred by convection 18 of the ambient air from external heat source 16 toward sensor element 3. Thermally insulated sensor housing cover 15, which is made of plastic, shields sensor element 3 both from infrared radiation 17, as well as from the heat that is transferred by convection 18.

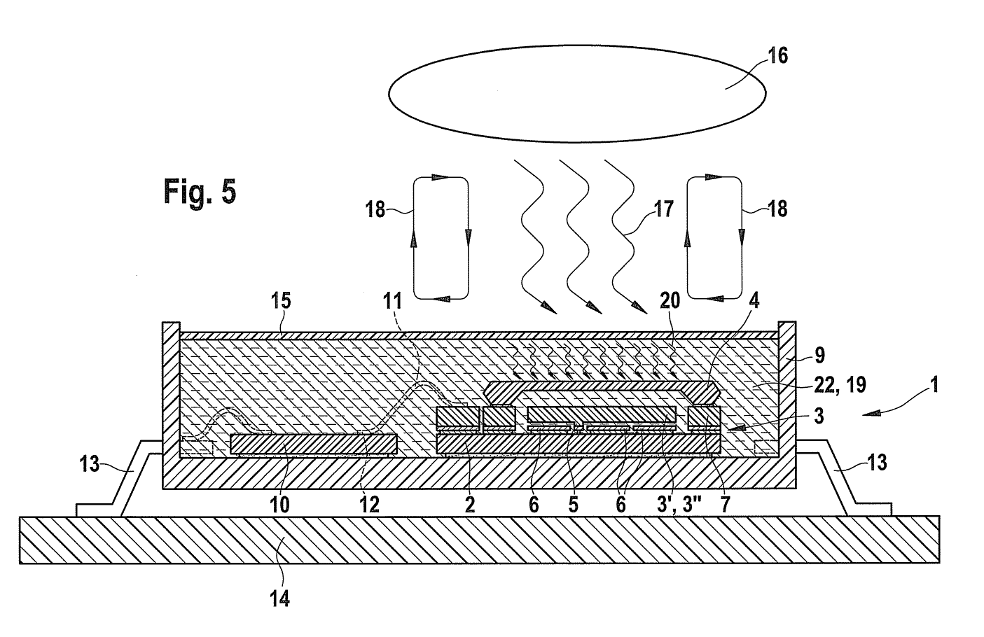

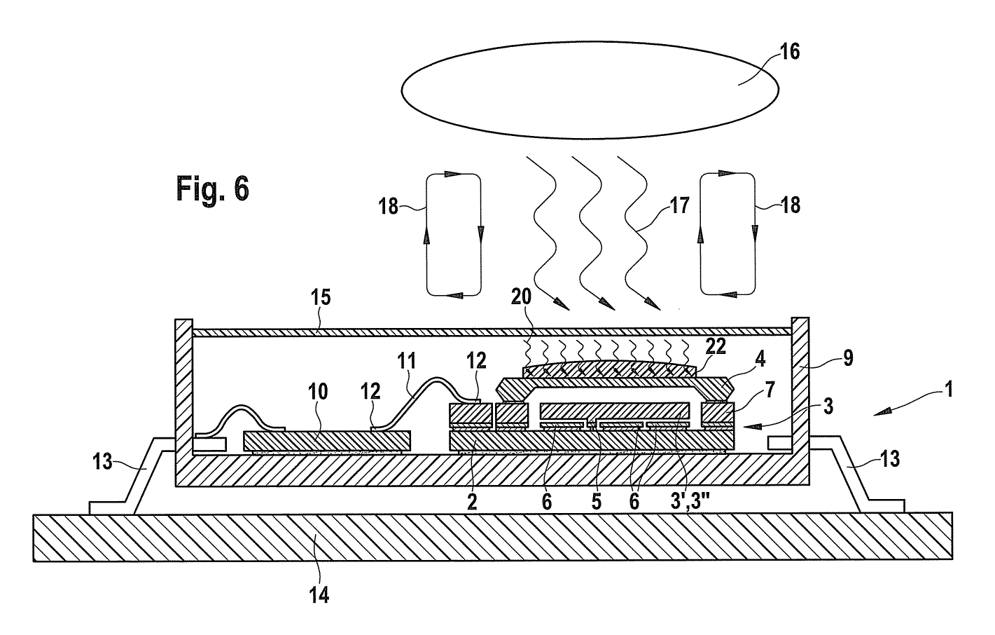

FIG. 5 shows a schematic sectional view of a sensor system 1 in accordance with a fifth specific embodiment of the present invention, the fifth specific embodiment being substantially identical to the fourth specific embodiment illustrated in FIG. 4, sensor housing 9 not having any infrared-protection element 8; rather sensor system 1 having a cover element 22 in the form of a potting compound 19, potting compound 19 being essentially located between sensor element 3 and sensor housing 9, and indirect infrared radiation 20, which, for example, is emitted from a heated sensor housing cover 15 in the direction of sensor element 3, being absorbed.

FIG. 6 shows a schematic sectional view of a sensor system 1 in accordance with a sixth specific embodiment of the present invention, the sixth specific embodiment being substantially identical to the fifth specific embodiment illustrated in FIG. 5, sensor housing 9 not having any potting compound 19; rather cover element 22 being designed in the form of an absorption element that is located on capping wafer 4 between sensor housing cover 15 and capping wafer 4 and that absorbs indirect infrared radiation 20, which, for example, is emitted from a heated sensor housing cover 15 in the direction of sensor element 3.

What is claimed is:

1. A sensor system, comprising:
a sensor element; and
a cover element, at least one side of the sensor element having a covering provided by the cover element, the cover element being at least partially designed as an infrared-protection element.

2. The sensor system according to claim 1, wherein the cover element has a capping wafer, a doped region of the capping wafer being provided as an infrared-protection element.

3. The sensor system according to claim 1, wherein the cover element encompasses at least one of a sensor housing and a sensor housing cover, the sensor element being configured at least partially within the sensor housing.

4. The sensor system according to claim 1, wherein a sensor housing cover that is thermally insulated from at least one of a sensor housing and the sensor element is provided as an infrared-protection element.

5. The sensor system according to claim 1, wherein the cover element includes a potting compound, which is situated at least one of (a) between a sensor housing and the sensor element and (b) between a sensor housing cover and the sensor element.

6. The sensor system according to claim 5, wherein the potting compound contains ruthenium oxide.

7. The sensor system according to claim 1, wherein the infrared-protection element encompasses a reflection and/or absorption element.

8. The sensor system according to claim 1, wherein the infrared-protection element includes at least one of a doped region, a metal layer, a dielectric layer, a dielectric layer stack and a plastic element.

9. The sensor system according to claim 1, wherein the infrared-protection element is situated on a side of the cover element facing the sensor element or on a side of the cover element facing away from the sensor element.

10. The sensor system according to claim 1, wherein the cover element includes at least one of (a) a doped region, (b) a coating of the sensor element and (c) a coating of a seismic mass of the sensor element.

11. The sensor system according to claim 1, wherein the sensor element includes an acceleration sensor that is sensitive, perpendicularly or in parallel to a main extension plane of a substrate of the sensor element.

12. The sensor system according to claim 1, wherein the sensor element has a seismic mass designed as a rocker structure having an asymmetrical mass distribution.

13. The sensor system according to claim 1, wherein the sensor system is an acceleration sensor system.
